(19) United States
(12) Patent Application Publication
(10) Pub. No.: US 2026/0253545 A1
(43) Pub. Date: Aug. 27, 2026

(54) DISPLAY DEVICE AND DRIVING METHOD THEREOF

(71) Applicant: LG Display Co., Ltd., Seoul (KR)

(72) Inventors: Sang Hyun PARK, Paju-si (KR); Ki Jin CHOI, Paju-si (KR)

(21) Appl. No.: 19/407,505

(22) Filed: Dec. 3, 2025

(30) Foreign Application Priority Data
Feb. 26, 2025 (KR) 10-2025-0024899

(51) Int. Cl. G09G 3/3233; G09G 3/20

(52) U.S. Cl. CPC G09G 3/3233; G09G 3/2092; G09G 2300/0842; G09G 2310/08; G09G 2320/0233; G09G 2320/0261; G09G 2330/028; G09G 2340/0435

(57) ABSTRACT

A display device and a driving method thereof. The display device includes a display panel in which an input image is displayed in a display area where a plurality of data lines, a plurality of gate lines, a plurality of reference voltage lines, and a plurality of sub-pixels are disposed; a data driver electrically connected to the data lines and the reference voltage lines; a gate driver electrically connected to the gate lines; and a power supply that has an output terminal for outputting a reference voltage to be applied to the reference voltage lines and the output terminal is configured to adjust a voltage level of the reference voltage in response to an instruction signal; and a timing controller configured to output the instruction signal and change a code of the instruction signal corresponding to a refresh rate of the input image.

### CROSS REFERENCE TO RELATED APPLICATION

This application claims priority from and the benefit of Korean Patent Application No. 10-2025-0024899, filed on Feb. 26, 2025, which is hereby incorporated by reference for all purposes as if fully set forth herein.

### BACKGROUND

### Field

Embodiments of the invention relate generally to a display device capable of variable refresh rate (VRR) driving and a driving method thereof.

### Discussion of the Background

Various flat panel displays, such as a liquid crystal display and an electroluminescence display, are known. The electroluminescence display may use light-emitting elements provided in each of pixels to emit light by itself without a backlight and may display an input image. The light-emitting elements of the electroluminescence display may be divided into organic light-emitting elements and inorganic light-emitting elements depending on a material for a light-emitting layer. An active matrix-type electroluminescence display has advantages of a high response speed, high light emission efficiency, high luminance, and a wide viewing angle since an organic light emitting diode (hereinafter, referred to as an "OLED") is provided in each pixel, and is excellent in contrast ratio and color reproducibility since a black grayscale can be expressed as absolute black.

The display device may support a variable refresh rate (VRR). The variable refresh rate may dynamically control a frame refresh rate (refresh rate, Hz) per second of an image that is reproduced on a screen of a display panel, without maintaining the frame refresh rate at a fixed value. The variable refresh rate may adjust the refresh rate according to frames per second (FPS) of content in displaying an image of the content, such as a game or animation on the display panel, thereby reducing problems such as tearing or stuttering in the image displayed on the screen. However, the variable refresh rate may cause luminance deviation in the image displayed on the display panel.

The above information disclosed in this Background section is only for understanding of the background of the inventive concepts, and, therefore, it may contain information that does not constitute prior art.

### SUMMARY

Display devices according to embodiments of the invention are capable of reducing luminance deviation between pixels that are driven at a variable refresh rate, and a driving method thereof.

Additional features of the inventive concepts will be set forth in the description which follows, and in part will be apparent from the description, or may be learned by practice of the inventive concepts.

According to one or more embodiments of the invention, a display device includes: a display panel in which an input image is displayed in a display area where a plurality of data lines, a plurality of gate lines, a plurality of reference voltage lines, and a plurality of sub-pixels are disposed; a data driver electrically connected to the data lines and the reference voltage lines; a gate driver electrically connected to the gate lines; a power supply that has an output terminal for outputting a reference voltage to be applied to the reference voltage lines and the output terminal is configured to adjust a voltage level of the reference voltage in response to an instruction signal; and a timing controller configured to output the instruction signal and change a code of the instruction signal corresponding to a refresh rate of the input image.

The timing controller may determine the refresh rate of the input image by counting a timing signal synchronized with the input image.

Each of the sub-pixels may include a light-emitting element and a driving transistor configured to drive the light-emitting element. When a refresh rate of the sub-pixels is higher from a first refresh rate to a second refresh rate, a gate-source voltage of the driving transistor may be greater.

A source voltage of the driving transistor may vary to change the gate-source voltage.

A reference voltage having a first voltage may be applied to the reference voltage lines when the sub-pixels are driven at a first refresh rate. A reference voltage having a second voltage higher than the first voltage may be applied to the reference voltage lines when the sub-pixels are driven at a second refresh rate lower than the first refresh rate.

The timing controller may be electrically connected to the power supply via a wire through which the instruction signal is transmitted.

The reference voltage may include: a reference voltage for display that is applied to the reference voltage lines in a display interval; and a reference voltage for sensing that is applied to the reference voltage lines in a sensing interval. The reference voltage for display may be a voltage higher than the reference voltage for sensing.

The data driver may include a sensing circuit that is electrically connected to the reference voltage lines and is configured to convert a voltage of the reference voltage line in the sensing interval into converted digital data and transmit the digital data to the timing controller.

Each of the sub-pixels may include: a light-emitting element; a driving transistor that includes a gate electrode connected to a first node, a first electrode to which a pixel driving voltage is applied, and a second electrode connected to a second node, and is configured to drive the light-emitting element with a current generated according to a gate-source voltage; a capacitor connected between the first node and the second node; a first transistor including a gate electrode connected to a first gate line, a first electrode connected to a data line, and a second electrode connected to the first node; and a second transistor including a gate electrode connected to a second gate line, a first electrode connected to the second node, and a second electrode connected to a reference voltage line. When the refresh rate is changed in a display interval, the reference voltage for display to be applied to the reference voltage line may be changed.

When the refresh rate is higher, the reference voltage to be applied to the reference voltage line may be lower. The reference voltage for sensing may be maintained at a fixed voltage regardless of the refresh rate.

The reference voltage for display may include a first voltage under a high refresh rate and a second voltage under a lower refresh rate, the second voltage being higher than the first voltage. The first voltage may be higher than the reference voltage for sensing.

The data driver may include a plurality of data channels electrically connected to the data line and a plurality of sensing channels electrically connected to the reference voltage line. The plurality of data channels may output the reference voltage for display in the display interval, and may output the reference voltage for sensing in the sensing interval. The sensing channel may output sensing data during the sensing interval.

The sensing channel may include the sensing circuit.

The power supply may be a power integrated circuit.

According to yet another embodiment of the invention, a method for driving a display device includes: determining the refresh rate of the input image; and, during a display interval where the input image is displayed on the display panel, transmitting an instruction signal corresponding to the refresh rate of the input image to the power supply such that a reference voltage to be output from the power supply varies corresponding to the refresh rate of the input image. The reference voltage is applied to reference voltage lines of the display panel.

The display panel may include a light-emitting element and a driving transistor configured to drive the light-emitting element. The refresh rate may be higher from a first refresh rate to second refresh rate, a gate-source voltage of the driving transistor is greater.

A source voltage of the driving transistor may vary to change the gate-source voltage.

The reference voltage may include: a reference voltage for display that is applied to a reference voltage line of the display panel during a display interval; and a reference voltage for sensing that is applied to the reference voltage line during a sensing interval. The reference voltage for display may be a voltage higher than the reference voltage for sensing.

When the refresh rate is higher, the reference voltage for display to be applied to the reference voltage line may be lower. The reference voltage for sensing may be maintained at a fixed voltage, regardless of the refresh rate.

According to yet another embodiment of the invention, a display device may include: a display panel in which an input image is displayed in a display area where a plurality of data lines, a plurality of gate lines, a plurality of reference voltage lines, and a plurality of sub-pixels are disposed; a data driver electrically connected to the data lines and the reference voltage lines; and a gate driver electrically connected to the gate lines. Each of the sub-pixels includes: a light-emitting element and a driving transistor configured to drive the light-emitting element. When a refresh rate of the sub-pixels is higher from a first refresh rate to a second refresh rate, a gate-source voltage of the driving transistor is greater.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIGS. 1A and 1B are diagrams illustrating a display device according to an embodiment of the invention.

FIG. 2 is a timing diagram illustrating an example of a sensing interval.

FIG. 3 is a timing diagram illustrating one frame interval of the display device according to an embodiment of the invention.

FIG. 4 is an equivalent circuit diagram illustrating a data driver electrically connected to a pixel circuit according to an embodiment of the invention.

FIG. 5 is a timing diagram illustrating an example where luminance of a pixel

may be different according to a refresh rate.

FIG. 6 is a flowchart illustrating a driving method of the display device according to an embodiment of the invention.

FIG. 7 is a timing diagram illustrating an example of a luminance control method of pixels according to an embodiment of the invention.

FIG. 8 is a timing diagram illustrating an example where a voltage level of a reference voltage is varied according to a refresh rate.

FIG. 9 is a diagram illustrating an example of pixel areas with different refresh rates in a screen of a display panel.

FIG. 10 is a diagram illustrating an example of reference voltages that are applied to the display device illustrated in FIG. 9.

### DETAILED DESCRIPTION

In the following description, for the purposes of explanation, numerous specific details are set forth in order to provide a thorough understanding of various embodiments or implementations of the invention. As used herein "embodiments" and "implementations" are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are show in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

In the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

The pixel circuit and the gate drive circuit of the display device may include a plurality of transistors. The transistor may be implemented as a thin film transistor (TFT). The transistors may be implemented as an oxide thin film transistor (Oxide TFT) including an oxide semiconductor, a low temperature poly silicon TFT (LTPS TFT) including a low temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor), since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage, and the gate-off voltage may be a gate low voltage VGL. In the case of a p-channel transistor, the gate-on voltage may be the gate low voltage VGL, and the gate-off voltage may be the gate high voltage.

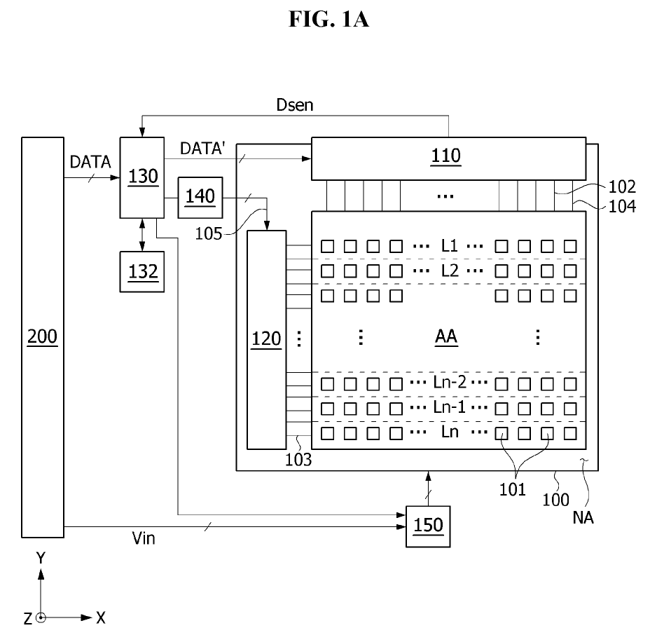

FIGS. 1A and 1B are diagrams illustrating a display device according to an embodiment of the invention.

Referring to FIGS. 1A and 1B, the display device according to the embodiment of the invention includes a display panel 100, display panel driving circuits, including data driver 110 and gate driver 120, that write pixel data to pixels 101 of the display panel 100, a power supply 150 that generates power necessary for driving the pixels 101, the data driver 110, and the gate driver 120, and the like.

The display panel 100 may be a rectangular panel having a breadth (or a width) in the X-axis direction, a length in the Y-axis direction, and a thickness in the Z-axis direction, but is not limited thereto. A screen of the display panel 100 may include a display area AA and a non-display area outside the display area AA. The display area AA of the display panel 100 includes a pixel array that displays an input image. The pixel array includes a plurality of data lines 102, a plurality of gate lines 103 intersecting the data lines 102, and pixels provided in a matrix. The display panel 100 may further include power lines (not shown) connected in common to two or more pixels. The power lines may be connected in common to pixel circuits and may supply voltages necessary for driving the pixels 101 to the pixels 101.

The data lines 102 are disposed in the form of long wires in the Y-axis direction of the display panel 100 and are electrically connected to data channels of a data driver 110. Reference voltage lines 104 may be disposed on the display panel in parallel to the data lines 102, and may be connected to the pixels and sensing channels of the data driver 110. The gate lines 103 are disposed in the form of long wires in the X-axis direction of the display panel 100, intersect the data lines 102, and are electrically connected to output terminals of the gate driver 120.

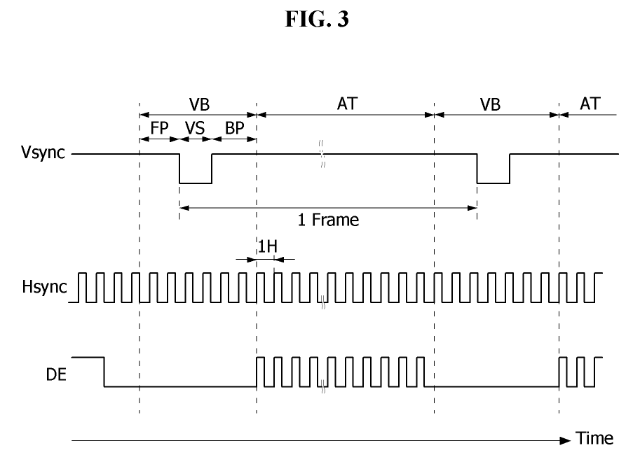

Each of the pixels 101 may be divided into a red sub-pixel, a green sub-pixel, and a blue sub-pixel for color implementation. Each of the pixels may further include a white sub-pixel. Each of the sub-pixels includes a pixel circuit to drive a light-emitting element. Each pixel circuit is connected to the data line, the gate lines, and the power lines. The pixel circuit may be implemented as a circuit illustrated in FIG. 4, but embodiments of the invention are not limited thereto.

The pixel array includes a plurality of pixel lines L1 to Ln. Each of the pixel lines L1 to Ln includes pixels of one line disposed in the X-axis direction in the pixel array of the display panel 100. The pixels disposed in one pixel line share the gate lines 103. The sub-pixels disposed in the Y-axis direction along the data line share the same data line 102. One horizontal interval 1 H is a time obtained by dividing one frame interval by the total number of pixel lines L1 to Ln.

The display panel 100 may be implemented as a non-transmissive display panel or a transmissive display panel. The transmissive display panel may be applied to a transparent display device in which an image is displayed on a screen and a real object in a background is visible. The display panel 100 may be manufactured as a flexible display panel.

The power supply 150 adjusts a level of a direct-current input voltage Vin applied from a host system 200 and outputs a first voltage V1 necessary for driving the pixel array of the display panel 100 and the display panel driving circuit. The power supply 150 may include a DC-DC converter. The DC-DC converter may include a charge pump, a regulator, a buck converter, a boost converter, and the like. The power supply 150 may output a gamma reference voltage, a gate high voltage, a gate low voltage, a pixel driving voltage, a pixel ground voltage, a reference voltage, an integrated circuit (IC) driving voltage, and the like through the DC-DC converter. The voltages that are output from the power supply 150 may be constant voltages (or direct-current voltages). The gamma reference voltage is supplied to the data driver 110. A dynamic range of a data voltage that is output from the data driver 110 is determined according to a voltage range of the gamma reference voltage. The dynamic range of the data voltage has a voltage range between a highest grayscale voltage and a lowest grayscale voltage. The voltage level of the data voltage is selected on the basis of a grayscale value of pixel data.

The gate high voltage and the gate low voltage are supplied to a level shifter 140 and the gate driver 120. The voltages such as the pixel driving voltage, the pixel ground voltage, and the reference voltage are supplied to the pixels 101 via the power lines in common with the pixels 101. The IC driving voltage is a driving voltage of a drive (source drive) embedded with circuits of a timing controller 130 and the data driver 110.

The power supply 150 may adjust an output voltage under the control of the timing controller 130. For example, the power supply 150 may be connected to the timing controller 130 via a wire 131 (FIG. 1B) in which a signal is transmitted through a serial interface such as I2C. The power supply 150 may include one or more voltage control registers that adjust a voltage level of an output voltage in response to an instruction signal received from the timing controller 130. The instruction signal includes a code of a register set value. When the register set value of the voltage control register of the power supply 150 is changed, a voltage level of an output voltage instructed by the voltage control register may be changed.

As illustrated in FIG. 1B, the timing controller 130 may be implemented as an application-specific integrated circuit (ASIC), and the power supply 150 may be implemented as a power IC, such as a power management integrated circuit (PMIC) or an electronics integrated circuit (ELIC). The ASIC and the power IC may be mounted on a control printed circuit board (PCB) electrically connected to the display panel 100. The ASIC may transmit an instruction signal instructing a voltage level of an output voltage of the power IC, for example, a reference voltage VpreR or VpreS via the wire 131 connected between the ASIC and the power IC. The ASIC changes a code of the instruction signal, for example, a code including the register set value corresponding to a refresh rate of an input image. The power IC includes an output terminal at which a voltage level is adjusted in response to the register set value of the instruction signal input from the ASIC. Accordingly, the timing controller 130 may output the instruction signal in which the code is changed according to the refresh rate of the input image, and the power IC may change the voltage level of the output voltage in response to the instruction signal in real time.

The display panel driving circuits, data driver 110 and gate driver 120, write pixel data of an input image to the pixels of the display panel 100 under the control of the timing controller 130. The data driver 110 and the gate driver 120 may further include demultiplexers (DEMUX) disposed between the data driver 110 and the data lines 102, but embodiments of the invention are not limited thereto. When the demultiplexers are disposed between output terminals of the data driver 110 and the data lines 102, the number of data channels of the data driver 110 may be reduced.

The display device may include a sensing circuit connected to the sub-pixels. The sensing circuit converts a sensing voltage obtained from the sub-pixels via the reference voltage line 104 into a digital signal (hereinafter, referred to as "sensing data") Dsen and transmits the converted digital signal to the timing controller 130. The sensing circuit may be disposed in a sensing channel of the data driver 110.

Touch sensors that sense a touch input may be disposed on the display panel 100. The touch sensors may be disposed on the display panel 100 as an on-cell type or an add-on type, or may be implemented as in-cell type touch sensors embedded in the pixel array.

The data driver 110 and the gate driver 120 may further include a touch sensor driver (not shown) for driving the touch sensors. The data driver 110 and the touch sensor driver may be integrated in one drive IC.

The data driver 110 includes data channels that are electrically connected to the data lines 102 and output data voltages, and sensing channels that are electrically connected to the reference voltage lines 104 and receive sensing voltages. The data channels receive the pixel data of the input image received as the digital signal from the timing controller 130 as input and output the data voltages during a display interval. The sensing channels sense the electrical characteristics of the pixels via the reference voltage line 104 during a sensing interval.

The data channels of the data driver 110 convert pixel data DATA' of an input image received from the timing controller 130 into a gamma compensation voltage using a digital-to-analog converter (hereinafter, referred to as "DAC") and output the data voltages of the pixel data. The gamma reference voltage is divided into grayscale-specific gamma compensation voltages through a voltage division circuit. The grayscale-specific gamma compensation voltages are provided to the DAC of the data driver 110. The data voltages are output from the respective channels of the data driver 110 via output buffers.

The sensing channels of the data driver 110 include an analog-to-digital converter (hereinafter, referred to as "ADC"). The sensing channels convert the sensing voltages received via the reference voltage lines 104 into digital data using the ADC and output the sensing data Dsen. The sensing data Dsen is transmitted to the timing controller 130.

The gate driver 120 may be arranged in at least one of right and left non-display areas NA outside the display area AA in the display panel 100 or at least a part of the gate driver 120 may be arranged in the display area AA.

The gate driver 120 may be arranged in the non-display areas NA on both sides of the display panel 100 with the display area AA of the display panel interposed therebetween and may supply gate pulses on both sides of the gate lines 103 using a double feeding method. In another embodiment, the gate driver 120 may be arranged in at least one of the right and left non-display areas AA of the display panel 100 and may supply gate signals to the gate lines 103 using a single feeding method. The gate driver 120 sequentially outputs the pulses of the gate signals to the gate lines 103 under the control of the timing controller 130. The gate driver 120 may sequentially supply the gate signals to the gate lines 103 by shifting the pulses of the gate signals using a shift register. A plurality of gate signals may be applied to the pixel circuit. In this case, the gate driver 120 may include a plurality of shift registers that output the pulses of the gate signals.

The timing controller 130 receives digital video data DATA of an input image and timing signals synchronized with the data from the host system 200. The timing signals may include a vertical synchronization signal Vsync, a horizontal synchronization signal Hsync, a data enable signal DE, and the like. Because a vertical interval and a horizontal interval can be known by a method of counting the data enable signal DE, the vertical synchronization signal Vsync and the horizontal synchronization signal Hsync may be omitted. The horizontal synchronization signal Hsync and the data enable signal DE have a cycle of one horizontal interval 1 H.

The timing controller 130 generates a data timing control signal to control an operation timing of the data driver 110 and a gate timing control signal to control an operation timing of the gate driver 120 on the basis of the timing signals Vsync, Hsync, and DE received from the host system 200. The timing controller 130 controls the operation timing of the display panel driving circuit, thereby synchronizing the data driver 110 and the gate driver 120.

The gate timing control signal output from the timing controller 130 may be input to the shift registers of the gate driver 120 via the level shifter 140. The level shifter 140 may convert the gate timing control signal received from the timing controller 130 via clock lines 105 to have a swing width between the gate high voltage and the gate low voltage and may provide the converted gate timing control signal to the gate driver 120. The gate timing control signal

that is output from the level shifter 140 may include a start signal, a clock, a line selection signal, a reset signal, and the like, but embodiments of the invention are not limited thereto. The gate driver 120 outputs the pulses of the gate signals to write pixel data to the sub-pixels during the display interval in response to the gate timing control signal input from the level shifter 140, and outputs the pulses of the gate signals to sense the electrical characteristics of the sub-pixels during the sensing interval.

The data driver 110 and the gate driver 120 may be driven at a variable refresh rate (VRR) under the control of the timing controller 130. For example, the timing controller 130 may decrease a refresh rate of an image displayed on the display panel 100 according to a frequency of an input image or on the basis of a result of analyzing the input image, thereby reducing the power consumption of the display device and improving image quality. The refresh rate of the image that is displayed on the display panel 100 may be varied to 60 Hz, 120 Hz, 144 Hz, 165 Hz, 240 Hz, and the like, according to the variable refresh rate, but embodiments of the invention are not limited thereto. For example, the refresh rate may be decreased to 1Hz.

The data driver 110 and the gate driver 120 may decrease the refresh rate of the pixels 101 when a still image is input for a given time under the control of the timing controller 130, thereby reducing the power consumption of the display device. The refresh rate may be decreased when the display device operates in a standby mode or in response to a user's command. Further, the refresh rate may be decreased on an “always on display” (AOD) screen. The AOD screen may be a partial pixel area of the display area AA where preset information, for example, brief information such as a remaining battery quantity and time is displayed in the standby mode.

The host system 200 may convert the resolution of an image signal from a video source to match the resolution of the display panel 100 and may transmit the converted image signal to the timing controller 130 along with the timing signals.

The sensing circuit may sequentially sense the sub-pixels of the display area AA during the preset sensing interval under the control of the timing controller 130, thereby sensing the electrical characteristics of the light-emitting elements and/or the driving transistors in all sub-pixels, for example, the mobility and the threshold voltage.

The timing controller 130 may determine the electrical characteristics of circuit elements in the sub-pixel, for example, the light-emitting element and the driving transistor on the basis of the sensing data Dsen received from the sensing circuit of the data driver 110. The timing controller 130 derives a compensation value to compensate for the optical and electrical characteristics of each sub-pixel on the basis of the sensing data Dsen. For example, the timing controller 130 may derive the compensation value to compensate for the optical and electrical characteristics on the basis of the sensing data Dsen by executing a preset compensation algorithm, or may input the sensing data Dsen to a look-up table (LUT) stored in a memory 132 and derive a compensation value output from the look-up table.

In the look-up table, compensation values corresponding to initial optical and characteristic characteristics measured by sub-pixel in an aging process and an inspection process of the display panel are set by sub-pixel. The compensation values stored in the look-up table may be updated according to a sensing value in which deterioration accumulated as the sub-pixels are driven for a longer time is reflected. A compensation circuit of the timing controller 130 may add or multiply the compensation value derived from the look-up table to pixel data of an input image, thereby compensating for electrical characteristic deviation and change of the light-emitting element and/or the driving transistor in each sub-pixel.

The memory 132 may store driving setting timing information of the data driver 110 and the gate driver 120, the look-up table from which the compensation values are derived on the basis of the sensing results of the sub-pixels, a program code of a compensation algorithm to improve image quality, and the like. The memory 132 may include a non-volatile memory or a volatile memory. The non-volatile memory may include one or more of readable and writable memories, for example, a NAND flash memory, a NOR flash memory, and an electrically erasable programmable read-only memory (EEPROM). The NAND flash memory may be a single level cell (SLC) type. The volatile memory may include one or more of a dynamic RAM (DRAM), a static RAM (SRAM), a synchronous dynamic RAM (SDRAM), and a double data rate SDRAM (DDR SDRAM).

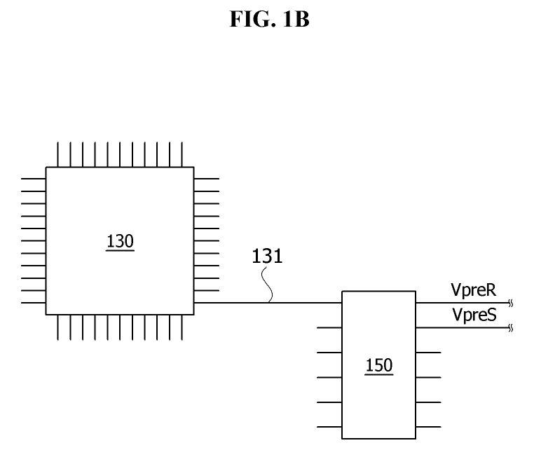

FIG. 2 is a timing diagram illustrating an example of a sensing interval.

As illustrated in FIG. 2, the sensing circuit may be driven during a sensing interval set in at least one of a power-on sequence in which power starts to be applied to the display device and a power-off sequence, and may sense the electrical characteristics of the sub-pixels. The sensing circuit may sense the electrical characteristics of the sub-pixels during a vertical blank interval VB in which pixel data is not present, in the display interval. During the sensing interval, the sensing data Dsen output from the sensing channels of the data driver 110 is transmitted to the timing controller 130.

In FIG. 2, "ON RF" represents the sensing interval of the sub-pixels in the power-on sequence. "OFF RS" represents the sensing interval of the sub-pixels in the power-off sequence. The mobility of the driving transistor disposed in each sub-pixel may be sensed during the sensing interval ON RF in the power-on sequence. The mobility of the driving transistor disposed in each sub-pixel may be sensed during the sensing interval OFF RS in the power-off sequence.

The power-off sequence OFF RS is a process in which power is turned off in a predetermined order when a user's command to turn on a power-off switch of the display device is received from the user. The timing controller 130, the sensing circuit of the data driver 110, and the gate driver 120 may be further driven for a predetermined time after the power-off switch is turned on in the power-off sequence OFF RS, and may be stopped when the output of the power supply is blocked after the electrical characteristics of the driving transistor and/or the light-emitting element in each sub-pixel are sensed.

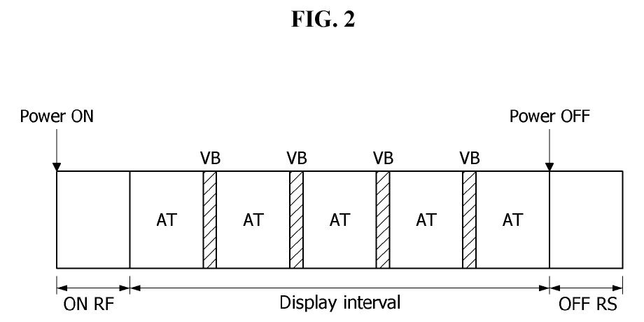

FIG. 3 is a timing diagram illustrating one frame interval of the display device. In FIG. 3, the vertical synchronization signal Vsync, the horizontal synchronization signal Hsync, and the data enable signal DE are the timing signals synchronized with the pixel data of the input image.

Referring to FIG. 3, one frame interval (1 Frame) is divided into an active interval AT and the vertical blank interval VB in which pixel data is not present. The vertical blank interval VB includes a vertical sync interval VS, a vertical front porch interval FP, and a vertical back porch interval BP.

The pixel data of the input image may be input to the timing controller 130 during the active interval AT, and the data driver 110 may output the data voltage. The vertical blank interval VB is an interval in which pixel data is not present, between an active interval AT of an (N-1)th (where N is a natural number) frame interval and an active interval AT of an N-th frame interval. The data driver 110 outputs the data voltage of the pixel during the active interval AT, but does not output the data voltage during the vertical blank interval VB. When the refresh rate is decreased, the vertical blank interval VB may be expanded and extended.

The vertical synchronization signal Vsync defines one frame interval. One pulse cycle of the horizontal synchronization signal Hsync and the data enable signal DE is one horizontal interval 1 H. The data enable signal DE defines a valid data interval in which the pixel data of the input image is present.

The refresh rate of the display panel 100 may be varied by a method of changing one horizontal interval 1 H without changing the vertical blank interval VB. For example, when the refresh rate is 144 Hz, pixel data that is written to the pixels is updated for each of 144 frame intervals per second. At the refresh rate of 144 Hz] one horizontal interval 1 H may be 3.08 µs. In contrast, when the refresh rate is 120 Hz, pixel data that is written to the pixels is updated for each of 120 frame intervals per second. At the refresh rate of 120 Hz, one horizontal interval 1 H may be decreased to 3.07 µs.

The refresh rate of the display panel 100 may be varied by a method of changing the vertical blank interval VB without changing one horizontal interval 1 H. Also in this case, when the refresh rate is 144 Hz, pixel data that is written to the pixels is updated for each of 144 frame intervals per second, and when the refresh rate is 120 Hz, pixel data that is written to the pixels is updated for each of 120 frame intervals per second.

When the refresh rate of the display panel 100 is changed, the number of frames per unit time in which pixel data is updated is different. For this reason, luminance deviation in the image reproduced on the display panel 100 may occur.

The timing controller 130 may determine a refresh rate of an input image with one horizontal interval 1 H changing and a refresh rate of an input image with the vertical blank interval VB changing in real time by counting the input timing signals Vsync, HE, and DE with the clock. The timing controller 130 may control a gate-source voltage of a driving transistor DR when an image is displayed at a high refresh rate to be higher than a gate-source voltage when an image is displayed at a relatively low refresh rate, on the basis of a determination result of the refresh rate of the input image. For example, the timing controller 130 may decrease the reference voltage VpreR (FIG. 1B) output from the power supply 150 when the refresh rate of the input image is higher, thereby controlling the gate-source voltage Vgs of the driving transistor DR to be greater. The timing controller 130 may increase the reference voltage VpreR output from the power supply 150 when the refresh rate of the input image is lower, thereby controlling the gate-source voltage Vgs of the driving transistor DR to be smaller.

FIG. 4 is an equivalent circuit diagram illustrating the data driver electrically connected to the pixel circuit according to an embodiment of the invention. The pixel circuit and the sensing circuit of the data driver are not limited to those in FIG. 4. In FIG. 4, "'SDIC" represents a drive IC in which the circuit of the data driver 110 is integrated.

Referring to FIG. 4, the pixel circuit may include a light-emitting element EL, a driving transistor DR, a capacitor Cst, a first switch transistor M1, and a second switch transistor M2.

The pixel circuit is connected to a data line 102, gate lines 1031 and 1032, a reference voltage line 104, a first constant voltage node 106 to which a pixel driving voltage EVDD is applied, and a second constant voltage node 107 to which a pixel ground voltage EVSS is applied. The constant voltage nodes 106 and 107 are connected to power lines connected in common to the pixels. The pixel driving voltage EVDD is set to a voltage at which the driving transistor DR operates in a saturation region. The pixel driving voltage EVDD is a voltage higher than a maximum voltage (or a white grayscale voltage) of a data voltage Vdata. The pixel ground voltage EVSS is a voltage lower than a minimum voltage (or a black grayscale voltage) of the data voltage Vdata.

The reference voltages VpreR and VpreS may include a display reference voltage VpreR and a sensing reference voltage VpreS having different voltage levels. The display reference voltage VpreR may be set to a voltage higher than the sensing reference voltage VpreS. For example, the display reference voltage VpreR may be 2 V, and the sensing reference voltage VpreS may be a ground voltage GND or 0 V, but embodiments of the invention are not limited thereto.

The display reference voltage VpreR may be applied to the reference voltage line 104 during a partial interval of the display interval. The display reference voltage VpreR is applied to the reference voltage line 104 via the second switch transistor M2 during the display interval, thereby setting a voltage of a second node n2, that is, a source voltage of the driving transistor DR to an appropriate voltage. The sensing reference voltage VpreS is not used during the display interval. The sensing reference voltage VpreS may be applied to the reference voltage line 104 during at least a partial interval of the sensing interval. The sensing reference voltage VpreS is applied to the reference voltage line 104 via the second switch transistor M2 at the beginning of the sensing interval, thereby discharging and initializing the reference voltage lines 104. The display reference voltage VpreR is not used during the sensing interval.

The light-emitting element EL may be an OLED, but is not limited thereto. The light-emitting element may include an anode electrode, a cathode electrode, and a light-emitting layer disposed between the anode electrode and the cathode electrode.

The driving transistor DR generates a current according to the gate-source voltage Vgs and drives the light-emitting element EL. The gate-source voltage Vgs of the driving transistor DR is equal to a voltage between a first node n1 and a second node n2. The driving transistor DR includes a gate electrode connected to the first node n1, a first electrode connected to the first constant voltage node 106, and a second electrode connected to the second node n2. The pixel driving voltage EVDD is applied to the first constant voltage node 106. The capacitor Cst is connected between the first node n1 and the second node n2, and is charged with the gate-source voltage of the driving transistor DR. In the embodiment, the gate-source voltage Vgs of the driving transistor DR is varied according to the refresh rate. The gate-source voltage Vgs may be varied according to the refresh rate in such a manner that the source voltage of the driving transistor DR, that is, the voltage of the second node n2, is changed while a gate voltage of the driving transistor DR is not changed.

The first switch transistor M1 is connected between the data line 102 and the first node n1, and is turned on in response to a gate on voltage of a first gate signal SCAN. When the first switch transistor M1 is turned on, the data line 102 is electrically connected to the first node n1. The first switch transistor M1 includes a gate electrode connected to a first gate line 1031 to which the first gate signal SCAN is applied, a first electrode connected to the data line 102, and a second electrode connected to the first node n1.

The second switch transistor M2 is connected between the second node n2 and the reference voltage line 104, and is turned on in response to a gate on voltage of a second gate signal SENSE. When the second switch transistor M2 is turned on, the reference voltage line 104 is electrically connected to the second node n2. The second switch transistor M2 includes a gate electrode connected to a second gate line 1032 to which the second gate signal SENSE is applied, a first electrode connected to the second node n2, and a second electrode connected to the reference voltage line 104.

The first and second transistors M1 and M2 may be turned on and off simultaneously by the same gate signal. In this case, the first and second transistors M1 and M2 may be connected to a single gate line.

The data driver 110 may include a plurality of data channels 112 and a plurality of sensing channels. The data channels 112 input the pixel data of the input image received from the timing controller 130 to the DAC of the data channels 112 and output the data voltage Vdata of the pixel data. The data channels 112 output the data voltage Vdata corresponding to the pixel data of the input image during the display interval, and output a preset data voltage for sensing during the sensing interval, regardless of the input image.

The sensing channels include the sensing circuit. The sensing circuit may include switch elements SAMP, RPRE, and SPRE electrically connected to the pixel circuit via the reference voltage line 104, and an ADC 300. The switch elements SAMP, RPRE, and SPRE may be implemented as transistors that are turned on and off under the control of a logic circuit in the data driver 110 or the timing controller 130.

When a sampling switch element SAMP is turned on, the reference voltage line 104 is electrically connected to the ADC of the ADC 300. A first reference voltage switch RPRE is turned on to supply the display reference voltage VpreR to the reference voltage line 104 during the display interval. A second reference voltage switch SPRE is turned on to supply the sensing reference voltage VpreS to the reference voltage line 104 during the sensing interval.

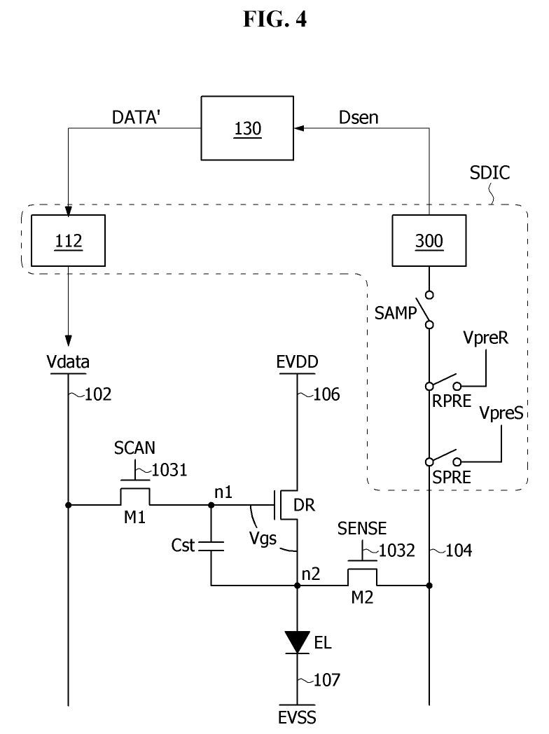

FIG. 5 is a timing diagram illustrating an example where luminance is different according to the refresh rate.

Referring to FIG. 5, after a rising interval in which an anode voltage of the light-emitting element EL is boosted to the driving voltage of the light-emitting element EL after the gate-source voltage of the driving transistor DR in each sub-pixel is charged in the capacitor Cst, the light-emitting element EL emits light. In FIG. 5, the light-emitting element EL is in a turn-off state until a rising interval of a luminance curve, and the light-emitting element EL may emit light during an emission interval in which the anode voltage of the light-emitting element EL rises to the driving voltage or higher at which the light-emitting element EL can emit light. In FIG. 5, A to E represent luminance when the light-emitting element EL emits light during the emission interval.

In the case of a low refresh rate LRR, during one frame interval, the number of times the anode voltage of the light-emitting element EL is boosted is small, and the emission interval is long. In the case of a high refresh rate HRR, during one frame interval, the number of times the anode voltage of the light-emitting element EL is boosted is greater, and the emission interval is shorter. On the condition that the gate-source voltage Vgs of the driving transistor DR is the same, when the refresh rate of the image written to the sub-pixels increases, the luminance of the pixels that display the image relatively decreases. As a result, when the pixels are driven at the variable refresh rate, luminance deviation between the pixels may be visible depending on the refresh rate.

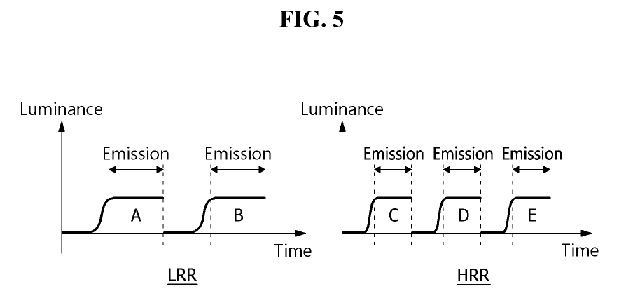

FIG. 6 is a flowchart illustrating a driving method of the display device according to an embodiment of the invention.

Referring to FIG. 6, the timing controller 130 receives the input image and determines the refresh rate of the input image (steps S1 and S2). The refresh rate of the input image may be analyzed as the frame frequency of the input image.

The timing controller 130 controls the data driver 110 and the gate driver 120 such that the pixel data of the input image is written to the pixels during the display interval. The timing controller 130 controls the gate-source voltage Vgs of the driving transistor DR to be small when the pixels are driven at the low refresh rate LRR during the display interval (steps S3 and S4). The timing controller 130 controls the gate-source voltage Vgs of the driving transistor DR to be large when the pixels are driven at the high refresh rate HRR during the display interval (steps S5 and S6). The greater the gate-source voltage Vgs of the driving transistor DR, the greater a current flowing into the light-emitting element EL, and the luminance of the pixels increases. Accordingly, luminance deviation caused by the change in refresh rate can be reduced.

The gate-source voltage Vgs of the driving transistor DR may be changed to one or more of the data voltage Vdata and the reference voltage VpreR. In the embodiment, by changing the reference voltage VpreR without changing the data voltage Vdata, the gate-source voltage Vgs of the driving transistor DR may be changed according to the refresh rate.

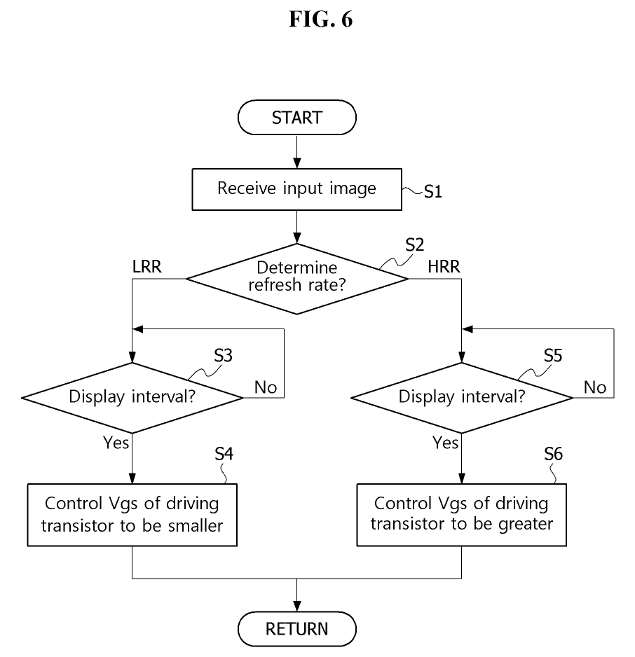

FIG. 7 is a timing diagram illustrating an example of a luminance control method of pixels according to an embodiment of the invention. In FIG. 7, A to E represent luminance when the light-emitting element EL emits light during the emission interval.

Referring to FIG. 7, pixel luminance at a low refresh rate LRR may be expressed as (Vdata - VpreR1) * T1. Here, VpreR1 is a reference voltage VpreR that is applied to the pixels to be driven at the low refresh rate LRR during the display interval, and T1 is a total of emission intervals A and B of the light-emitting element EL at the low refresh rate LRR.

Pixel luminance at a high refresh rate HRR may be expressed as (Vdata - VpreR2) * T2. Here, VpreR2 is a reference voltage VpreR that is applied to the pixels to be driven at the high refresh rate HRR during the display interval, and T2 is a total of emission intervals C, D, and E of the light-emitting element EL at the high refresh rate HRR.

When A + B = C + D + E, the luminance deviation between the pixels at the variable refresh rate can be minimized. To this end, in the embodiment, the reference voltage VpreR is controlled to be decreased such that the gate-source voltage Vgs of the driving transistor DR is increased at the high refresh rate HRR. In other words, in the embodiment, the reference voltage VpreR is controlled to be VpreR1 > VpreR2 when the refresh rate is increased.

The timing controller 130 may perform control such that the power supply 150 decreases the voltage level of the reference voltage VpreR when the refresh rate is increased. As a result, when the refresh rate of the pixels is increased, the gate-source voltage of the driving transistor DR is increased, and accordingly, the difference in luminance between the pixels can be reduced while the pixels are being driven at the variable refresh rate.

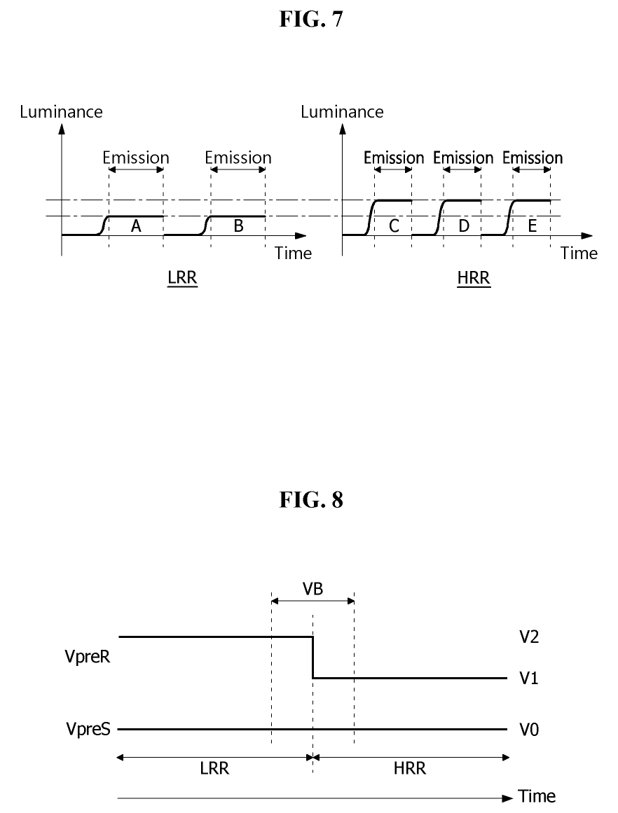

FIG. 8 is a timing diagram illustrating an example where the voltage level of the reference voltage is varied according to the refresh rate.

Referring to FIG. 8, the display reference voltage VpreR may be changed between a first voltage V1 and a second voltage V2. The first voltage V1 is a voltage lower than the second voltage V2. The display reference voltage VpreR may be the second voltage V2 at the low refresh rate LRR, and may be decreased to the first voltage V1 at the high refresh rate HRR. The voltage level of the display reference voltage VpreR may be changed in the vertical blank interval VB.

The sensing reference voltage VpreS may be maintained at a voltage V0 lower than the first voltage V1, regardless of the refresh rate. The voltage V0 of the sensing reference voltage VpreS may be a voltage lower than the voltages V1 and V2 of the display reference voltage VpreR.

The screen of the display panel 100 may be controlled at the same refresh rate during one frame interval, and may be varied in refresh rate in units of frame interval. In another embodiment, the screen of the display panel 100 may be controlled at different refresh rates locally.

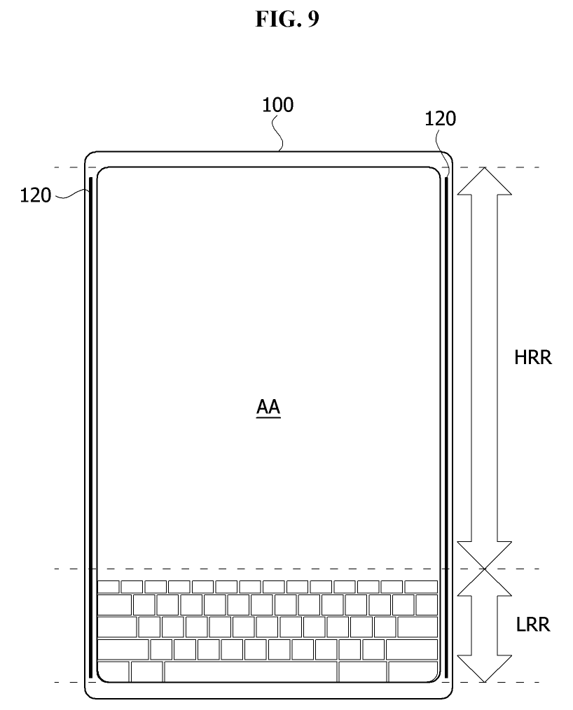

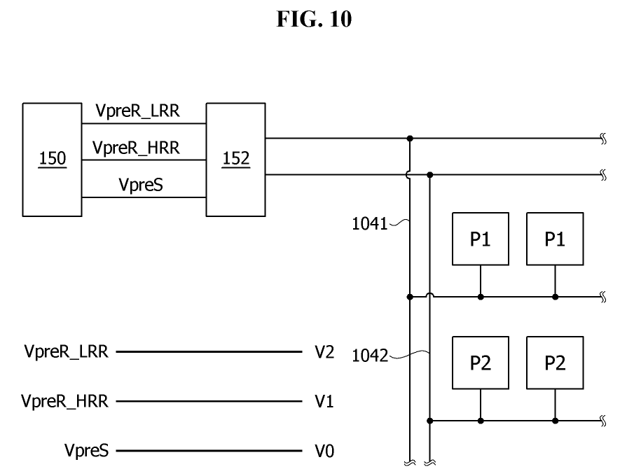

FIG. 9 is a diagram illustrating an example of pixel areas with different refresh rates in the screen of the display panel. FIG. 10 is a diagram illustrating an example of reference voltages that are applied to the display device illustrated in FIG. 9.

Referring to FIGS. 9 and 10, a display area AA may include a first pixel area and a second pixel area that are driven at different refresh rates HRR and LRR. The positions and sizes of the first pixel area and the second pixel area may not be fixed in the display area AA and may be varied according to the content of the input image or the determination result of the refresh rate.

While pixels P1 in the first pixel area may be driven at the high refresh rate HRR, pixels P2 in the second pixel area may be driven at the low refresh rate LRR. The first pixel area includes pixels that are driven at the high refresh rate HRR because scene conversion is fast, for a moving image or game content. The second pixel area includes pixels that are driven at the low refresh rate LRR because scene conversion is slow, for a still image or a soft keyboard screen.

As illustrated in FIG. 10, the display reference voltage VpreR may be divided into a first reference voltage VpreR_HRR that is applied to the pixels to be driven at the high refresh rate HRR and a second reference voltage VpreR_LRR that is applied to the pixels to be driven at the low refresh rate LRR. In FIGS. 8 and 10, a relationship of V0 < V1 < V2 may be established.

The power supply 150 may output the first reference voltage VpreR_HRR and the second reference voltage VpreR_LRR, and may change the voltage levels of the reference voltages VpreR_HRR and VpreR_LRR under the control of the timing controller 130. The reference voltages VpreR_HRR, VpreR_LRR, and VpreS output from the power supply 150 may be applied to reference voltage lines via a switch part 152. The switch part 152 supplies the reference voltages VpreR_HRR and VpreR_LRR for display to reference voltage lines 1041 and 1042 selected according to the refresh rate using a plurality of switch elements.

When the pixels P1 in the first pixel area are driven at the high refresh rate HRR, the first reference voltage VpreR_HRR may be applied to a first reference voltage line 1041 connected to the pixels P1 in the first pixel area via the switch part 152. When the pixels P2 in the second pixel area are driven at the low refresh rate LRR, the second reference voltage VpreR_LRR may be applied to a second reference voltage line 1042 connected to the pixels P2 in the second pixel area via the switch part 152. When the pixels P1 in the first pixel area are driven at the low refresh rate LRR, the second reference voltage VpreR_LRR may be applied to the first reference voltage line 1041 connected to the pixels P1 in the first pixel area via the switch part 152. When the pixels P2 in the second pixel area are driven at the high refresh rate HRR, the first reference voltage VpreR_HRR may be applied to the second reference voltage line 1042 connected to the pixels P2 in the second pixel area via the switch part 152.

According to one or more embodiments of the invention, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the invention may be applied to organic light emitting lighting devices or inorganic light emitting lighting devices.

According to embodiments of the invention, it is possible to reduce luminance deviation between the pixels to be driven at the variable refresh rate by changing the gate-source voltage of the driving transistor according to the refresh rate.

According to embodiments of the invention, it is possible to reduce power consumption and provide image quality optimum for the content of the input image by driving the display device at the variable refresh rate.

According to embodiments of the invention, it is possible to apply various variable refresh rates in a compatible manner by determining a variable refresh rate with a fixed vertical blank interval and a variable horizontal interval and a variable refresh rate with a fixed horizontal interval and a fixed vertical blank interval.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a display panel configured to display an input image in a display area, the display area including a plurality of data lines, a plurality of gate lines, a plurality of reference voltage lines, and a plurality of sub-pixels;
a data driver electrically connected to the data lines and the reference voltage lines;
a gate driver electrically connected to the gate lines;
a power supply including an output terminal for outputting a reference voltage to be applied to the reference voltage lines, the output terminal being configured to adjust a voltage level of the reference voltage in response to an instruction signal; and
a timing controller configured to output the instruction signal and change a code of the instruction signal corresponding to a refresh rate of the input image.

2. The display device according to claim 1, wherein the timing controller is configured to determine the refresh rate of the input image by counting a timing signal synchronized with the input image.

3. The display device according to claim 1, wherein:
each of the sub-pixels includes:
a light-emitting element; and
a driving transistor configured to drive the light-emitting element; and
when a refresh rate of the sub-pixels is higher from a first refresh rate to a second refresh rate, a gate-source voltage of the driving transistor is greater.

4. The display device according to claim 3, wherein a source voltage of the driving transistor varies to change the gate-source voltage.

5. The display device according to claim 1, wherein:
a reference voltage having a first voltage is applied to the reference voltage lines when the sub-pixels are driven at a first refresh rate; and
a reference voltage having a second voltage higher than the first voltage is applied to the reference voltage lines when the sub-pixels are driven at a second refresh rate lower than the first refresh rate.

6. The display device according to claim 1, further comprising a wire electrically connecting the timing controller to the power supply,
wherein the instruction signal is transmitted through the wire.

7. The display device according to claim 1, wherein the reference voltage includes:
a reference voltage for display that is applied to the reference voltage lines in a display interval; and
a reference voltage for sensing that is applied to the reference voltage lines in a sensing interval,
wherein the reference voltage for display is a voltage higher than the reference voltage for sensing.

8. The display device according to claim 7, wherein the data driver includes a sensing circuit that is electrically connected to the reference voltage lines and is configured to convert a voltage of the reference voltage line in the sensing interval into converted digital data and transmit the digital data to the timing controller.

9. The display device according to claim 7, wherein each of the sub-pixels includes:
a light-emitting element;
a driving transistor including a gate electrode connected to a first node, a first electrode to which a pixel driving voltage is applied, and a second electrode connected to a second node, the driving transistor being configured to drive the light-emitting element with a current generated according to a gate-source voltage;
a capacitor connected between the first node and the second node;
a first transistor including a gate electrode connected to a first gate line, a first electrode connected to a data line, and a second electrode connected to the first node; and
a second transistor including a gate electrode connected to a second gate line, a first electrode connected to the second node, and a second electrode connected to a reference voltage line,
wherein, when the refresh rate is changed in a display interval, the reference voltage for display to be applied to the reference voltage line is changed.

10. The display device according to claim 9, wherein:
when the refresh rate is higher, the reference voltage to be applied to the reference voltage line is lower; and
the reference voltage for sensing is maintained at a fixed voltage regardless of the refresh rate.

11. The display device according to claim 9, wherein:
the reference voltage for display comprises a first voltage under a high refresh rate and a second voltage under a lower refresh rate;
the second voltage is higher than the first voltage; and
the first voltage is higher than the reference voltage for sensing.

12. The display device according to claim 8, wherein:
the data driver comprises a plurality of data channels electrically connected to the data line and a plurality of sensing channels electrically connected to the reference voltage line;
the plurality of data channels output the reference voltage for display in the display interval, and output the reference voltage for sensing in the sensing interval; and
the sensing channel outputs sensing data during the sensing interval.

13. The display device according to claim 12, wherein the sensing channel comprises the sensing circuit.

14. The display device according to claim 1, wherein the power supply comprises a power integrated circuit.

15. A method for driving a display device that changes a refresh rate of an input image to be displayed on a display panel, the method comprising:
determining the refresh rate of the input image; and
during a display interval where the input image is displayed on the display panel, transmitting an instruction signal corresponding to the refresh rate of the input image to a power supply such that a reference voltage to be output from the power supply varies corresponding to the refresh rate of the input image,
wherein the reference voltage is applied to reference voltage lines of the display panel.

16. The method for driving a display device according to claim 15, wherein:
the display panel includes:
a light-emitting element; and
a driving transistor configured to drive the light-emitting element; and
when the refresh rate is higher from a first refresh rate to a second refresh rate, a gate-source voltage of the driving transistor is greater.

17. The method for driving a display device according to claim 16, wherein a source voltage of the driving transistor varies to change the gate-source voltage.

18. The method for driving a display device according to claim 15, wherein:
the reference voltage includes:
a reference voltage for display that is applied to a reference voltage line of the display panel during a display interval; and
a reference voltage for sensing that is applied to the reference voltage line during a sensing interval; and
the reference voltage for display is a voltage higher than the reference voltage for sensing.

19. The method for driving a display device according to claim 18, wherein:
when the refresh rate is higher, the reference voltage for display to be applied to the reference voltage line is lower; and
the reference voltage for sensing is maintained at a fixed voltage, regardless of the refresh rate.

20. A display device comprising:
a display panel configured to display an input image in a display area, the display area including a plurality of data lines, a plurality of gate lines, a plurality of reference voltage lines, and a plurality of sub-pixels are disposed;
a data driver electrically connected to the data lines and the reference voltage lines; and
a gate driver electrically connected to the gate lines,
wherein:
each of the sub-pixels includes:
a light-emitting element; and
a driving transistor configured to drive the light-emitting element; and
when a refresh rate of the sub-pixels is higher from a first refresh rate to a second refresh rate, a gate-source voltage of the driving transistor is greater.
